(19) United States
(12) Patent Application Publication
(10) Pub. No.: US 2017/0370788 A1
(43) Pub. Date: Dec. 28, 2017

(54) ARRANGEMENT FOR MEASURING A FORCE OR A TORQUE, USING AT LEAST THREE MAGNETIC SENSORS

(71) Applicant: Schaeffler Technologies AG & Co. KG, Herzogenaurach (DE)

(72) Inventors: Stephan Neuschaefer-Rube, Herzogenaurach (DE); Jens Heim, Bergrheinfeld (DE)

(73) Assignee: Schaeffler Technologies AG & Co. KG, Herzogenaurach (DE)

(21) Appl. No.: 15/540,722

(22) PCT Filed: Jan. 27, 2016
(86) PCT No.: PCT/DE2016/200049

§ 371 Date: Jun. 29, 2017

(30) Foreign Application Priority Data
Feb. 9, 2015 (DE) 10 2015 202 240.4

(51) Int. Cl. G01L 3/10; G01L 1/12

(52) U.S. Cl. CPC G01L 3/102; G01L 1/122; G01L 1/125

(57) ABSTRACT

The present invention relates to an arrangement for measuring a force and/or a torque (Mt) on a machine element extending along an axis, using the inverse magnetostrictive effect. The machine element has at least two magnetization areas for magnetization purposes, extending circumferentially around the axis. In addition, there are magnetically neutral areas, each area being arranged axially between the magnetization areas and/or axially next to the magnetization areas. The arrangement further includes at least one first magnetic sensor, a second magnetic sensor and a third magnetic sensor, each of which is designed to individually measure a direction component of a magnetic field caused by the magnetization and also by the force and/or torque (Mt) and each of which lies in a different axial position. According to the invention, the third magnetic sensor lies in an axial position of one of the magnetically neutral areas.

### BACKGROUND

The present invention relates to an arrangement for measuring a force and/or a torque on a machine element extending along an axis with at least three magnetic field sensors using the inverse magnetostrictive effect.

From US 2012/0296577 A1, a magneto-elastic force sensor is known that is formed for the measurement of forces on an element that is magnetized circumferentially.

U.S. Pat. No. 5,321,985 teaches a magnetostrictive torque sensor in which a magnetostrictive layer is formed on the outer surface of a shaft and is positioned opposite excitation and detection coils. A torque acting on the shaft causes a material tension in the magnetostrictive layer, whereby its relative magnetic permeability changes as a function of direction. The magnetic field emerging from the magnetostrictive layer can be measured with the detection coils.

DE 699 36 138 T2 shows a magnetic force sensor in which a magnetized material is exposed to a bending moment, wherein the external magnetic field of the magnetized material can be determined with the help of a sensor arrangement.

From DE 603 09 678 T2, a method for detecting a torque in a shaft is known, in which magnetic fields are generated with alternating polarity that are measured with a sensor arrangement.

US 2007/0022809 A1 shows a device for the measurement of torques in which a layer is formed from a magnetostrictive material in a shaft.

From U.S. Pat. No. 5,052,232, a magneto-elastic torque sensor is known in which a machine element is provided with two circumferential magnetostrictive coatings.

From DE 698 38 904 T2, a torque sensor with a circular magnetization is known. The magnetization is formed in a ferromagnetic, magnetostrictive material of a shaft and extends in a circular shape about the shaft.

From DE 692 22 588 T2, a ring-shaped magnetized torque sensor is known.

WO 2007/048143 A2 teaches a sensor with a magnetized shaft.

WO 01/27638 A1 shows an acceleration sensor with a shaft that is magnetized circumferentially or longitudinally.

From WO 2006/053244 A2, a torque sensor is known that comprises a magnetization on a rotating shaft. The magnetization is formed circumferentially.

U.S. Pat. No. 8,191,431 B2 shows a sensor arrangement with a magnetized shaft.

EP 2 365 927 B1 shows a bottom bracket with two foot pedals and with a chain ring carrier that is connected to a shaft of the bottom bracket. The chain ring carrier is locked in rotation with a chain ring shaft that is connected, in turn, locked in rotation with the shaft. The chain ring shaft has a magnetization in some sections. A sensor is provided that detects a change in the magnetization in the event of a torque in the area of the magnetization.

U.S. Pat. No. 6,490,934 B2 teaches a magneto-elastic torque sensor for the measurement of a torque that acts on an element with a ferromagnetic, magnetostrictive, and magneto-elastic active area. This area is formed in a measurement transducer that sits, for example, on a shaft as a cylindrical sleeve. The torque sensor is opposite the measurement transducer.

From EP 0 803 053 B1, a torque sensor is known that comprises a magneto-elastic measurement transducer. The measurement transducer sits on a shaft as a cylindrical sleeve.

U.S. Pat. No. 8,893,562 B2 teaches a method for detecting a magnetic interference field for a torque measurement on a magneto-elastic shaft. Two signals are measured, wherein the second signal corresponds to the magnetic interference field and is subtracted from the first signal.

U.S. Pat. No. 8,001,849 B2 shows an arrangement for the magneto-elastic torque measurement in which the effect of external magnetic fields is to be compensated. The arrangement comprises a magnetized area of a shaft and also at least one passive and one active magnetic field sensor. The passive magnetic field sensors can be arranged on both sides of the magnetized area.

US 2011/0162464 A1 shows an arrangement for the magneto-elastic torque measurement in which the effect of equally shaped and unequally shaped magnetic fields is to be compensated. The arrangement comprises a magnetized area of a shaft and also at least three magnetic field sensors. The second and the third magnetic field sensor can be arranged next to the magnetized area.

U.S. Pat. No. 8,087,304 B2 shows a magneto-elastic torque sensor for the measurement of a torque acting on a shaft. The shaft has one or more circumferential magnetizations. FIG. 12 of U.S. Pat. No. 8,087,304 B2 shows an embodiment with only one circumferential magnetization, wherein two primary magnetic field sensors are arranged in the area of the magnetization and two secondary magnetic field sensors are arranged next to the area of the magnetization. FIG. 18 of U.S. Pat. No. 8,087,304 B2 shows an embodiment with two circumferential magnetizations that are polarized alternately, wherein also multiple magnetic field sensors are arranged at an axial transition between the two magnetizations. FIG. 8 of U.S. Pat. No. 8,087,304 B2 shows an embodiment with three circumferential magnetizations that are polarized alternately, wherein each magnetic field sensor is arranged in one of the areas of the three magnetizations. Through the special arrangement of the magnetic field sensors, the influence of magnetic interference fields is to be canceled.

### SUMMARY

Starting from the prior art, the objective of the present invention is expanding the options for reducing the magnetic interference fields for a measurement of forces and/or torques using the inverse magnetostrictive effect.

The specified objective is achieved by an arrangement according to one or more features of the invention.

The arrangement according to the invention is used for measuring a force and/or a torque on a machine element extending along an axis. The force or the torque acts on the machine element, which leads to mechanical tension and the machine element is at least slightly deformed. The axis preferably forms a rotational axis of the machine element.

The machine element has at least two magnetization areas extending circumferentially about the axis for a magnetization formed in the machine element. This involves at least two magnetization areas surrounding the axis, i.e., circular magnetization areas, wherein the axis itself does not preferably form a part of the magnetization areas. The magnetization areas have a tangential orientation with respect to a surface of the machine element extending about the axis. The magnetization areas preferably have only a tangential orientation with respect to the surface of the machine element extending about the axis. The magnetization areas extend preferably along a closed path about the axis, wherein the magnetization areas may have short gaps. The magnetization areas each form a primary sensor for determining the force or the torque. The magnetization areas preferably have an equal spatial extent. The magnetization areas are preferably each formed in an axial section of the machine element.

The machine element further has magnetically neutral areas each of which is arranged axially between the magnetization areas and/or axially next to the magnetization areas of the machine element. The machine element has at least one of the magnetically neutral areas. The magnetically neutral areas do not have a permanent magnetization nor is the arrangement constructed such that the magnetically neutral areas are magnetized temporarily. Obviously, undesired magnetic interference fields could lead to a temporary magnetization of the magnetically neutral areas. The magnetically neutral areas are preferably not magnetized. The magnetically neutral areas are preferably formed each in an axial section of the machine element.

The arrangement further comprises at least one first magnetic field sensor, one second magnetic field sensor, and one third magnetic field sensor, each of which forms a secondary sensor for determining the force or the torque. The primary sensors, i.e., the magnetization areas, are used for converting the force to be measured or the torque to be measured into a corresponding magnetic field, while the secondary sensors enable the conversion of this magnetic field into electrical signals. The first magnetic field sensor, the second magnetic field sensor, and the third magnetic field sensor are each formed for the individual measurement of a directional component of a magnetic field caused by the magnetization and also by the force and/or by the torque. The specified magnetic field occurs due to the inverse magnetostrictive effect. Thus, the measurement possible with the arrangement according to the invention uses the inverse magnetostrictive effect.

The magnetic field sensors are arranged opposite the machine element, wherein preferably there is only a small radial distance between the magnetic field sensors and an inner or outer surface of the machine element. The first magnetic field sensor, the second magnetic field sensor, and the third magnetic field sensor are located at three different axial positions. At each of the axial positions of the first magnetic field sensor, the second magnetic field sensor, and the third magnetic field sensor, there is one of the magnetization areas or one of the magnetically neutral areas, i.e., the machine element is basically formed at these axial positions.

According to the invention, the third magnetic field sensor is located at an axial position of one of the magnetically neutral areas. Thus, the third magnetic field sensor is not arranged radially adjacent to one of the magnetization areas, but is instead arranged radially adjacent to one of the magnetically neutral areas. This magnetically neutral area can be arranged axially between two of the magnetization areas or axially adjacent to the magnetization areas.

One particular advantage of the arrangement according to the invention is that it permits a reliable reduction of magnetic interference fields in different constructions.

The at least two magnetization areas can be permanently or temporarily magnetized. For preferred embodiments of the arrangement according to the invention, the magnetization areas are permanently magnetized, so that the magnetization is formed by a permanent magnetization. In alternative preferred embodiments of the arrangement according to the invention, this arrangement further has at least one magnet for magnetizing the magnetization areas, so that the magnetization of the magnetization areas is basically temporary. The at least one magnet can be formed by a permanent magnet or preferably by an electromagnet.

The permanently or temporarily magnetized magnetization areas are, in a state of the machine element unloaded by a force or by a torque, preferably magnetically neutral to the outside of the magnetization areas, so that no technically relevant magnetic field can be measured outside of the magnetization areas.

The magnetization areas each represent a part of the volume of the machine element. The magnetization areas preferably each have a ring-shaped form, wherein the axis of the machine element also forms a center axis of the respective ring shape. In an especially preferred way, the magnetization areas each have the shape of a hollow cylinder coaxial to the axis of the machine element.

The directional component that can be measured with the magnetic field sensors is preferably selected from the following group of directions: a direction parallel to the axis, i.e., an axial direction, and a direction radial to the axis, i.e., a radial direction.

The arrangement according to the invention basically comprises preferably more than three of the magnetic field sensors, in an especially preferred way, four or eight of the magnetic field sensors. The at least three magnetic field sensors preferably have an equal distance to the axis of the machine element. The at least three magnetic field sensors can basically be arranged outside of the machine element or also within a hollow space of the machine element, for example, if the machine element is formed by a hollow shaft.

The magnetization areas each preferably feature a high magnetostrictive effect.

The magnetization areas are preferably arranged at an axial distance to each other, wherein one of the magnetically neutral areas is arranged between two adjacent magnetization areas. If there are more than two of the magnetization areas, each of these preferably has an equal distance to each other.

The machine element preferably has the shape of a prism or a cylinder, wherein the prism or the cylinder is arranged coaxial to the axis. The prism or the cylinder is preferably straight. In an especially preferred way, the machine element has the shape of a straight circular cylinder, wherein the circular cylinder is arranged coaxial to the axis. In special embodiments, the prism or the cylinder has a conical shape. The prism or the cylinder can also be hollow.

The machine element is preferably formed by a shaft, a hollow shaft, a switching fork, or a flange. The shaft, the switching fork, or the flange can be designed for loads through different forces and torques and can be, for example, a component of a sensor bottom bracket, a roll stabilizer, or a manure distributor. In principle, the machine element could also be formed by completely different types of machine elements.

The at least three magnetic field sensors are preferably each formed by a semiconductor sensor. The at least three magnetic field sensors are alternatively formed preferably by Hall sensors, coils, flux gates, or flux gate magnetometers. In principle, other sensor types could also be used, if they are suitable for measuring an individual directional component of the magnetic field caused by the inverse magnetostrictive effect.

In a first group of preferred embodiments of the arrangement according to the invention, the directional component of the magnetic field caused by the magnetization and also by the force and/or by the torque, wherein this directional component can be measured by the magnetic field sensors, is formed by an axial directional component. The magnetic field sensors thus enable the exclusive measurement of the axial directional component of the magnetic field caused by the magnetization and also by the force and/or by the torque. The first magnetic field sensor is located in this first group of preferred embodiments at an axial position of the first magnetization area, while the second magnetic field sensor is located at an axial position of the second magnetization area. Thus, the first magnetic field sensor is located at an axial position in which the first magnetization area is formed, while the second magnetic field sensor is located at an axial position in which the second magnetization area is formed. Consequently, the first magnetic field sensor is arranged radially adjacent to the first magnetization area, while the second magnetic field sensor is arranged radially adjacent to the second magnetization area.

In the first group of preferred embodiments of the arrangement according to the invention, this preferably further comprises a fourth magnetic field sensor for the individual measurement of an axial directional component of the magnetic field caused by the magnetization and also by the force and/or by the torque. The fourth magnetic field sensor is preferably arranged at an identical axial position as the first magnetic field sensor, at an identical axial position as the second magnetic field sensor, or at an identical axial position as the third magnetic field sensor.

In the first group of preferred embodiments of the arrangement according to the invention, the first magnetization area extending circumferentially about the axis and the second magnetization area extending circumferentially about the axis preferably have the same polarity, i.e., they have an identical orientation. The magnetically neutral area at whose axial position the third magnetic field sensor is located is arranged axially between the first magnetization area and the second magnetization area. Thus, the third magnetic field sensor is also arranged axially between the two magnetization areas.

In a first embodiment of the first group of preferred embodiments of the arrangement according to the invention, this arrangement further comprises a fourth magnetic field sensor for the individual measurement of an axial directional component of the magnetic field caused by the magnetization and also by the force and/or by the torque. The fourth magnetic field sensor is arranged at an identical axial position as the third magnetic field sensor. It is arranged opposite the third magnetic field sensor with respect to the axis. Consequently, the third magnetic field sensor and the fourth magnetic field sensor have a center angle of 180° relative to each other on the axis. In this first embodiment, the first magnetization area and the second magnetization area have the same polarity, i.e., they have an identical orientation. The magnetically neutral area at whose axial position the third magnetic field sensor is located is arranged axially between the two magnetization areas. Thus, the third magnetic field sensor is also arranged axially between the two magnetization areas.

In this first embodiment, the first magnetic field sensor is arranged preferably opposite the second magnetic field sensor with respect to the axis. Consequently, the first magnetic field sensor and the second magnetic field sensor have a center angle of 180° relative to each other with respect to the axis.

In this first embodiment, the first magnetic field sensor and the third magnetic field sensor preferably have an identical tangential position, so that they preferably lie together on a straight line parallel to the axis. The second magnetic field sensor and the fourth magnetic field sensor preferably have an identical tangential position so that they preferably lie together on a straight line parallel to the axis.

In this first embodiment, the magnetic field sensors are preferably arranged and wired such that a difference from the sum of the axial directional components that can be measured with the first magnetic field sensor and with the second magnetic field sensor and the sum of the axial directional components that can be measured with the third magnetic field sensor and with the fourth magnetic field sensor can be determined. The specified axial directional components are the axial directional components of the magnetic field that is caused by the magnetization and also by the force and/or by the torque and over which a magnetic interference field can be superimposed. The specified sum and difference formation can be realized, for example, such that the magnetic field sensors forming a subtrahend are oriented opposite the magnetic field sensors forming a minuend. The specified sum and difference formation, however, can also be realized such that the magnetic field sensors are oriented identically and a sum is formed from their signals, wherein the magnetic field sensors forming a subtrahend are reverse polarized.

In a second embodiment of the first group of preferred embodiments of the arrangement according to the invention, this arrangement further comprises a fourth magnetic field sensor, a fifth magnetic field sensor, a sixth magnetic field sensor, a seventh magnetic field sensor, and an eighth magnetic field sensor that are each formed for the individual measurement of an axial directional component of the magnetic field caused by the magnetization and also by the force and/or by the torque. In this second embodiment, the first magnetization area and the second magnetization area have the identical polarity, i.e., they have the identical orientation. The magnetically neutral area at whose axial position the third magnetic field sensor is located is arranged axially between the two magnetization areas. Thus, the third magnetic field sensor is also arranged axially between the two magnetization areas.

In this second embodiment, the fourth magnetic field sensor is preferably arranged at an identical axial position as the third magnetic field sensor. It is arranged opposite the third magnetic field sensor with respect to the axis. Consequently, the third magnetic field sensor and the fourth magnetic field sensor have a center angle of 180° with respect to each other relative to the axis.

In this second embodiment, the fifth magnetic field sensor is preferably arranged at an identical axial position as the first magnetic field sensor. It is preferably arranged opposite the first magnetic field sensor with respect to the axis. Consequently, the fifth magnetic field sensor and the first magnetic field sensor have a center angle of 180° with respect to each other relative to the axis.

In this second embodiment, the sixth magnetic field sensor is preferably arranged at an identical axial position as the second magnetic field sensor. It is arranged opposite the second magnetic field sensor with respect to the axis. Consequently, the sixth magnetic field sensor and the second magnetic field sensor have a center angle of 180° with respect to each other relative to the axis.

In this second embodiment, the seventh magnetic field sensor is arranged at an identical axial position as the third magnetic field sensor. At least the seventh magnetic field sensor is arranged at an axial position of that of the magnetically neutral areas at whose axial position the third magnetic field sensor is also arranged. The seventh magnetic field sensor is preferably arranged adjacent to the third magnetic field sensor, so that its tangential or radial position is also scarcely different from that of the third magnetic field sensor.

In this second embodiment, the eighth magnetic field sensor is preferably arranged at an identical axial position as the seventh magnetic field sensor. It is arranged opposite the seventh magnetic field sensor with respect to the axis. Consequently, the eighth magnetic field sensor and the seventh magnetic field sensor have a center angle of 180° with respect to each other relative to the axis.

The first magnetic field sensor, the second magnetic field sensor, and the third magnetic field sensor have, in this second embodiment, preferably an identical tangential position, so that they lie preferably together on a straight line parallel to the axis. The seventh magnetic field sensor is preferably arranged directly adjacent to the third magnetic field sensor, so that the seventh magnetic field sensor has at least approximately the same tangential position as the third magnetic field sensor. The seventh magnetic field sensor and the third magnetic field sensor can be arranged, for example, on the two sides of a circuit board.

The fourth magnetic field sensor, the fifth magnetic field sensor, and the sixth magnetic field sensor have, in this second embodiment, preferably an identical tangential position, so that they preferably lie together on a straight line parallel to the axis. The eighth magnetic field sensor is preferably arranged directly adjacent to the fourth magnetic field sensor, so that the eighth magnetic field sensor has at least approximately the same tangential position as the fourth magnetic field sensor. The eighth magnetic field sensor and the fourth magnetic field sensor can be arranged, for example, on the two sides of a circuit board.

In this second embodiment, the magnetic field sensors are preferably arranged and wired such that a difference from the sum of the axial directional components that can be measured with the first magnetic field sensor, with the second magnetic field sensor, with the fifth magnetic field sensor, and with the sixth magnetic field sensor and the sum of the axial directional components that can be measured with the third magnetic field sensor, with the fourth magnetic field sensor, with the seventh magnetic field sensor, and with the eighth magnetic field sensor can be determined. The specified axial directional components are the axial directional components of the magnetic field that is caused by the magnetization and also by the force and/or by the torque and over which a magnetic interference field can be superimposed. The specified sum and difference formation can be realized, for example, in that the magnetic field sensors forming a subtrahend are oriented opposite the magnetic field sensors forming a minuend. The specified sum and difference formation can also be realized, however, such that the magnetic field sensors have identical orientation and a sum is formed from their signals, wherein the magnetic field sensors forming a subtrahend are reverse polarized.

In the first group of preferred embodiments of the arrangement according to the invention, the first magnetization area and the second magnetization area have alternating polarities that are preferably opposite each other, i.e., they have an opposite orientation. The magnetically neutral area at whose axial position the third magnetic field sensor is located is then preferably located axially next to the magnetization areas, so that this magnetically neutral area is axially adjacent only to one of the magnetization areas. Thus, the third magnetic field sensor is also arranged axially next to the magnetization areas.

In a third embodiment of the first group of preferred embodiments of the arrangement according to the invention, this arrangement further comprises a fourth magnetic field sensor for the individual measurement of an axial directional component of the magnetic field that is caused by the magnetization and also by the force and/or by the torque and that is arranged at the identical axial position as the second magnetic field sensor. It is arranged opposite the second magnetic field sensor with respect to the axis. Consequently, the fourth magnetic field sensor and the second magnetic field sensor have a center angle of 180° with respect to each other relative to the axis. In this third embodiment, the first magnetization area and the second magnetization area preferably have opposite polarities, i.e., they have opposite orientation. The magnetically neutral area at whose axial position the third magnetic field sensor is located is located axially next to the magnetization areas. Thus, the third magnetic field sensor is also arranged axially next to the magnetization areas. The second magnetic field sensor is preferably located axially between the first magnetic field sensor and the third magnetic field sensor.

In this third embodiment, the first magnetic field sensor is preferably arranged opposite the third magnetic field sensor with respect to the axis. Consequently, the third magnetic field sensor and the first magnetic field sensor have a center angle of 180° with respect to each other relative to the axis.

The first magnetic field sensor and the second magnetic field sensor have, in this third embodiment, preferably an identical tangential position, so that they lie preferably together on a straight line parallel to the axis. The third magnetic field sensor and the fourth magnetic field sensor have, in this third embodiment, preferably an identical tangential position, so that they preferably lie together on a straight line parallel to the axis.

In this third embodiment, the magnetic field sensors are preferably arranged and wired so that a difference from the sum of the axial directional components that can be measured with the first magnetic field sensor and with the third magnetic field sensor and the sum of the axial directional components that can be measured with the second magnetic field sensor and with the fourth magnetic field sensor can be determined. The specified axial directional components are the axial directional components of the magnetic field that is caused by the magnetization and also by the force and/or by the torque and over which a magnetic interference field can be superimposed. The specified sum and difference formation can be realized, for example, such that the magnetic field sensors forming a subtrahend are oriented opposite the magnetic field sensors forming a minuend. The specified sum and difference formation, however, can also be realized such that the magnetic field sensors have identical orientation and a sum is formed from their signals, wherein the magnetic field sensors forming a subtrahend are reverse polarized.

In a fourth embodiment of the first group of preferred embodiments of the arrangement according to the invention, this arrangement further comprises a fourth magnetic field sensor, a fifth magnetic field sensor, a sixth magnetic field sensor, a seventh magnetic field sensor, and an eighth magnetic field sensor, each of which are formed for the individual measurement of an axial directional component of the magnetic field caused by the magnetization and also by the force and/or b the torque. In this fourth embodiment, the first magnetization area and the second magnetization area preferably have opposite polarities, i.e., they have an opposite orientation. The magnetically neutral area at whose axial position the third magnetic field sensor is located, is located axially next to the magnetization areas. Thus, the third magnetic field sensor is also arranged axially next to the magnetization areas. The second magnetic field sensor is preferably located axially between the first magnetic field sensor and the third magnetic field sensor.

In this fourth embodiment, the fourth magnetic field sensor is preferably arranged at an identical axial position as the third magnetic field sensor. It is arranged opposite the third magnetic field sensor with respect to the axis. Consequently, the fourth magnetic field sensor and the third magnetic field sensor have a center angle of 180° with respect to each other relative to the axis.

In this fourth embodiment, the fifth magnetic field sensor is preferably arranged at an identical axial position as the first magnetic field sensor. It is arranged opposite the first magnetic field sensor with respect to the axis. Consequently, the fifth magnetic field sensor and the first magnetic field sensor have a center angle of 180° with respect to each other relative to the axis.

In this fourth embodiment, the sixth magnetic field sensor is arranged opposite the third magnetic field sensor with respect to the axis. Consequently, the sixth magnetic field sensor and the third magnetic field sensor have a center angle of 180° with respect to each other relative to the axis.

In this second embodiment, the seventh magnetic field sensor is arranged at an identical axial position as the second magnetic field sensor. At least the seventh magnetic field sensor is arranged at an axial position of the second magnetization area. The seventh magnetic field sensor is arranged adjacent to the second magnetic field sensor, so that also it's tangential or radial position is scarcely different from that of the second magnetic field sensor.

In this fourth embodiment, the eighth magnetic field sensor is preferably arranged at an identical axial position as the seventh magnetic field sensor. It is arranged opposite the seventh magnetic field sensor with respect to the axis. Consequently, the eighth magnetic field sensor and the seventh magnetic field sensor have a center angle of 180° with respect to each other relative to the axis.

The first magnetic field sensor, the second magnetic field sensor, and the third magnetic field sensor have, in this fourth embodiment, preferably an identical tangential position, so that they preferably lie together on a straight line parallel to the axis. The seventh magnetic field sensor is preferably arranged directly adjacent to the second magnetic field sensor, so that the seventh magnetic field sensor has at least approximately the identical tangential position as the second magnetic field sensor. The seventh magnetic field sensor and the second magnetic field sensor can be arranged, for example, on the two sides of a circuit board.

The fourth magnetic field sensor, the fifth magnetic field sensor, and the sixth magnetic field sensor have, in this fourth embodiment, preferably an identical tangential position, so that they preferably lie together on a straight line parallel to the axis. The eighth magnetic field sensor is preferably arranged directly adjacent to the sixth magnetic field sensor, so that the eighth magnetic field sensor has at least approximately the identical tangential position as the sixth magnetic field sensor. The eighth magnetic field sensor and the sixth magnetic field sensor can be arranged, for example, on the two sides of a circuit board.

In this fourth embodiment, the magnetic field sensors are preferably arranged and wired such that a difference from the sum of the axial directional components that can be measured with the first magnetic field sensor, with the third magnetic field sensor, with the fourth magnetic field sensor, and with the fifth magnetic field sensor and the sum of the axial directional components that can be measured with the second magnetic field sensor, with the sixth magnetic field sensor, with the seventh magnetic field sensor, and with the eighth magnetic field sensor can be determined. The specified axial directional components are the axial directional components of the magnetic field that is caused by the magnetization and also by the force and/or by the torque and over which a magnetic interference field can be superimposed. The specified sum and difference formation can be realized, for example, such that the magnetic field sensors forming a subtrahend have opposite orientation to the magnetic field sensors forming a minuend. The specified sum and difference formation can, however, also be realized, such that the magnetic field sensors have identical orientation and a sum is formed from their signals, wherein the magnetic field sensors forming a subtrahend are reverse polarized.

In a second group of preferred embodiments of the arrangement according to the invention, the directional component of the magnetic field caused by the magnetization and also by the force and/or by the torque, wherein this directional component can be measured by the magnetic field sensors, is formed by a radial directional component. The magnetic field sensors thus enable the exclusive measurement of the radial directional component of the magnetic field caused by the magnetization and also by the force and/or by the torque. The first magnetic field sensor is located at an axial position of one of the magnetically neutral areas. The second magnetic field sensor is also located at an axial position of one of the magnetically neutral areas. Thus, the first magnetic field sensor is located at an axial position in which one of the magnetically neutral areas is formed. The second magnetic field sensor is also located at an axial position in which one of the magnetically neutral areas is formed. Consequently, the first magnetic field sensor is arranged radially adjacent to one of the magnetically neutral areas. The second magnetic field sensor is also arranged radially adjacent to one of the magnetically neutral areas.

In this second group of preferred embodiments, one of the magnetization areas is located preferably axially between two axially adjacent magnetic field sensors. The magnetic field sensors are thus located axially next to the magnetization areas on both sides of the magnetization areas. Preferably the second magnetic field sensor is located at an axial position of one of the magnetically neutral areas that is arranged axially between the first magnetization area and the second magnetization area. The first magnetization area is preferably located axially between the first magnetic field sensor and the second magnetic field sensor.

In the second group of preferred embodiments of the arrangement according to the invention, the first magnetization area extending circumferentially about the axis and the second magnetization area extending circumferentially about the axis preferably have opposite polarities, i.e., they have opposite orientation. The magnetically neutral area at whose axial position the third magnetic field sensor is located is arranged axially next to the magnetization areas, so that this magnetically neutral area is axially adjacent only to one of the magnetization areas, namely preferably to the second magnetization area. The second magnetization area is preferably located axially between the second magnetic field sensor and the third magnetic field sensor.

In a first embodiment of the second group of preferred embodiments of the arrangement according to the invention, this arrangement further comprises a fourth magnetic field sensor for the individual measurement of a radial directional component of the magnetic field caused by the magnetization and also by the force and/or by the torque. The fourth magnetic field sensor is arranged in an identical axial position as the second magnetic field sensor. It is arranged opposite the second magnetic field sensor with respect to the axis. Consequently, the second magnetic field sensor and the fourth magnetic field sensor have a center angle of 180° with respect to each other relative to the axis. In this first embodiment, the first magnetization area and the second magnetization area have different polarities, i.e., they have an opposite orientation.

In this first embodiment, the first magnetic field sensor is arranged opposite the third magnetic field sensor with respect to the axis. Consequently, the first magnetic field sensor and the third magnetic field sensor have a center angle of 180° with respect to each other and relative to the axis.

In this first embodiment, the first magnetic field sensor and the second magnetic field sensor preferably have an identical tangential position, so that preferably they lie together on a straight line parallel to the axis. The third magnetic field sensor and the fourth magnetic field sensor preferably have an identical tangential position, so that they preferably lie together on a straight line parallel to the axis.

In this first embodiment, the magnetic field sensors are preferably arranged and wired such that a difference from the sum of the radial directional components that can be measured with the first magnetic field sensor and with the fourth magnetic field sensor and the sum of the radial directional components that can be measured with the second magnetic field sensor and with the third magnetic field sensor can be determined. The specified radial directional components are the radial directional components of the magnetic field that is caused by the magnetization and also by the force and/or by the torque and over which a magnetic interference field can be superimposed. The specified sum and difference formation can be realized, for example, such that the magnetic field sensors forming a subtrahend are oriented opposite the magnetic field sensors forming a minuend. The specified sum and difference formation, however, can also be realized such that the magnetic field sensors have an identical orientation and a sum is formed from their signals, wherein the magnetic field sensors forming a subtrahend are reverse polarized.

In a second embodiment of the second group of preferred embodiments of the arrangement according to the invention, this arrangement further comprises a fourth magnetic field sensor, a fifth magnetic field sensor, a sixth magnetic field sensor, a seventh magnetic field sensor, and an eighth magnetic field sensor, each of which are formed for the individual measurement of a radial directional component of the magnetic field caused by the magnetization and also by the force and/or by the torque. The fourth magnetic field sensor is arranged at an identical axial position as the third magnetic field sensor. It is arranged opposite the third magnetic field sensor relative to the axis. Consequently, the fourth magnetic field sensor and the third magnetic field sensor have a center angle of 180° with respect to each other relative to the axis. In this second embodiment, the first magnetization area and the second magnetization area have different polarities, i.e., they have an opposite orientation.

In this second embodiment, the fifth magnetic field sensor is arranged at the same axial position as the first magnetic field sensor. It is arranged opposite the first magnetic field sensor with respect to the axis. Consequently, the fifth magnetic field sensor and the first magnetic field sensor have a center angle of 180° with respect to each other relative to the axis.

In this second embodiment, the sixth magnetic field sensor is arranged at the same axial position as the second magnetic field sensor. It is arranged opposite the second magnetic field sensor with respect to the axis. Consequently, the sixth magnetic field sensor and the second magnetic field sensor have a center angle of 180° with respect to each other relative to the axis.

In this second embodiment, the eighth magnetic field sensor is arranged at the same axial position as the seventh magnetic field sensor. It is arranged opposite the seventh magnetic field sensor with respect to the axis. Consequently, the eighth magnetic field sensor and the seventh magnetic field sensor have a center angle of 180° with respect to each other relative to the axis.

In this second embodiment, the first magnetic field sensor, the second magnetic field sensor, and the third magnetic field sensor preferably have an identical tangential position, so that they preferably lie together on a straight line parallel to the axis. The seventh magnetic field sensor is preferably arranged directly adjacent to the second magnetic field sensor, so that they are opposite the same magnetically neutral area and have approximately the same position.

In this second embodiment, the fourth magnetic field sensor, the fifth magnetic field sensor, and the sixth magnetic field sensor preferably have an identical tangential position, so that they preferably lie together on a straight line parallel to the axis. The eighth magnetic field sensor is preferably arranged directly adjacent to the sixth magnetic field sensor, so that they are opposite the same magnetically neutral area and have approximately the same position.

In this second embodiment, the magnetic field sensors are preferably arranged and wired such that a difference from the sum of the radial directional components that can be measured with the first magnetic field sensor, with the third magnetic field sensor, with the sixth magnetic field sensor, and with the eighth magnetic field sensor and the sum of the radial directional components that can be measured with the second magnetic field sensor, with the fourth magnetic field sensor, with the fifth magnetic field sensor, and with the seventh magnetic field sensor can be determined. The specified radial directional components are radial directional components of the magnetic field that is caused by the magnetization and also by the force and/or by the torque and over which a magnetic interference field can be superimposed. The specified sum and difference formation can be realized, for example, such that the magnetic field sensors forming a subtrahend are oriented opposite the magnetic field sensors forming a minuend. The specified sum and difference formation, however, can also be realized such that the magnetic field sensors have the identical orientation and a sum is formed from their signals, wherein the magnetic field sensors forming a subtrahend are reverse polarized.

In the second group of preferred embodiments of the arrangement according to the invention, the machine element alternatively and preferably further has a third magnetization area extending circumferentially about the axis for a magnetization. The first magnetization area and the third magnetization area preferably have an identical polarity, i.e., they have an identical orientation that is opposite the polarity of the second magnetization area. The magnetically neutral area at whose axial position the third magnetic field sensor is located is located axially next to the magnetization areas, so that this magnetically neutral area is adjacent axially only to one of the magnetization areas, namely preferably to the third magnetization area. Thus, the third magnetic field sensor is also arranged axially next to the magnetization areas.

In a third embodiment of the second group of preferred embodiments of the arrangement according to the invention, this arrangement further comprises a fourth magnetic field sensor for the individual measurement of a radial directional component of the magnetic field caused by the magnetization and also by the force and/or by the torque. The fourth magnetic field sensor is also located at an axial position of one of the magnetically neutral areas. The fourth magnetic field sensor is preferably arranged axially between the second magnetic field sensor and the third magnetic field sensor, but also axially between the second magnetization area and the third magnetization area. In this third embodiment, the first magnetization area and the third magnetization area have an identical polarity that is opposite the polarity of the second magnetization area.

In this third embodiment, the first magnetic field sensor is arranged opposite the third magnetic field sensor with respect to the axis. Consequently, the first magnetic field sensor and the third magnetic field sensor have a center angle of 180° with respect to each other relative to the axis. The first magnetic field sensor is preferably located axially next to the three magnetization areas on the opposite axial end as the third magnetic field sensor. The second magnetic field sensor is located preferably axially between the first magnetization area and the second magnetization area. The fourth magnetic field sensor is preferably located axially between the second magnetization area and the third magnetization area.

In this third embodiment, the first magnetic field sensor and the second magnetic field sensor preferably have an identical tangential position, so that they preferably lie together on a straight line parallel to the axis.

In this third embodiment, the third magnetic field sensor and the fourth magnetic field sensor preferably have an identical tangential position, so that they preferably lie together on a straight line parallel to the axis.

In this third embodiment, the magnetic field sensors are preferably arranged and wired such that a difference from the sum of the radial directional components that can be measured with the first magnetic field sensor and with the third magnetic field sensor and the sum of the radial directional components that can be measured with the second magnetic field sensor and with the fourth magnetic field sensor can be determined. The specified radial directional components are the radial directional components of the magnetic field that is caused by the magnetization and also by the force and/or by the torque and over which a magnetic interference force can be superimposed. The specified sum and difference formation can be realized, for example, such that the magnetic field sensors forming a subtrahend are oriented opposite the magnetic field sensors forming a minuend. The specified sum and difference formation, however, can also be realized such that the magnetic field sensors have the identical orientation and a sum is formed from their signals, wherein the magnetic field sensors forming a subtrahend are reverse polarized.

In a fourth embodiment of the second group of preferred embodiments of the arrangement according to the invention, this arrangement further comprises a fourth magnetic field sensor, a fifth magnetic field sensor, a sixth magnetic field sensor, a seventh magnetic field sensor, and an eighth magnetic field sensor, each of which are formed for the individual measurement of a radial directional component of the magnetic field caused by the magnetization and also by the force and/or by the torque. The fourth magnetic field sensor, the fifth magnetic field sensor, the sixth magnetic field sensor, and the seventh magnetic field sensor are each located at an axial position of one of the magnetically neutral areas. The fourth magnetic field sensor is arranged at the identical axial position as the third magnetic field sensor. It is arranged opposite the third magnetic field sensor with respect to the axis. Consequently, the fourth magnetic field sensor and the third magnetic field sensor have a center angle of 180° with respect to each other relative to the axis. In this third embodiment, the first magnetization area and the third magnetization area have an identical polarity that is opposite the polarity of the second magnetization area.

In this fourth embodiment, the fifth magnetic field sensor is arranged at the same axial position as the first magnetic field sensor. It is arranged opposite the first magnetic field sensor with respect to the axis. Consequently, the fifth magnetic field sensor and the first magnetic field sensor have a center angle of 180° with respect to each other relative to the axis. The first magnetic field sensor and the fifth magnetic field sensor are preferably located axially next to the three magnetization areas at the opposite axial end as the third magnetic field sensor and the fourth magnetic field sensor. The second magnetic field sensor is preferably located axially between the first magnetization area and the second magnetization area.

In this fourth embodiment, the sixth magnetic field sensor is arranged at the same axial position as the second magnetic field sensor. It is arranged opposite the second magnetic field sensor with respect to the axis. Consequently, the sixth magnetic field sensor and the second magnetic field sensor have a center angle of 180° with respect to each other relative to the axis.

In this fourth embodiment, the seventh magnetic field sensor is preferably arranged axially between the second magnetization area and the third magnetization area.

In this fourth embodiment, the eighth magnetic field sensor is arranged at the same axial position as the seventh magnetic field sensor. It is arranged opposite the seventh magnetic field sensor with respect to the axis. Consequently, the eighth magnetic field sensor and the seventh magnetic field sensor have a center angle of 180° with respect to each other relative to the axis.

In this fourth embodiment, the first magnetic field sensor, the second magnetic field sensor, the third magnetic field sensor, and the seventh magnetic field sensor have preferably an identical tangential position so that they lie preferably together on a straight line parallel to the axis.

In this fourth embodiment, the fourth magnetic field sensor, the fifth magnetic field sensor, the sixth magnetic field sensor, and the eighth magnetic field sensor preferably have an identical tangential position so that they lie preferably together on a straight line parallel to the axis.

In this fourth embodiment, the magnetic field sensors are preferably arranged and wired such that a difference from the sum of the radial directional components that can be measured with the first magnetic field sensor, with the fourth magnetic field sensor, with the sixth magnetic field sensor, and with the seventh magnetic field sensor and the sum of the radial directional components that can be measured with the second magnetic field sensor, with the third magnetic field sensor, with the fifth magnetic field sensor, and with the eighth magnetic field sensor can be determined. The specified radial directional components are radial directional components of the magnetic field that is caused by the magnetization and also by the force and/or by the torque and over which a magnetic interference field can be superimposed. The specified sum and difference formation can be realized, for example, such that the magnetic field sensor forming a subtrahend are oriented opposite the magnetic field sensors forming a minuend. The specified sum and difference formation, however, can also be realized such that the magnetic field sensors have an identical orientation and a sum is formed from their signals, wherein the magnetic field sensors forming a subtrahend are reverse polarized.

### BRIEF DESCRIPTION OF THE DRAWINGS

Additional details, advantages, and refinements of the invention are given in the following description of preferred embodiments of the invention with reference to the drawing. Shown are:

FIG. 1 a first embodiment of a first group of preferred embodiments of an arrangement according to the invention,

FIG. 2 a second embodiment of the first group of preferred embodiments of an arrangement according to the invention,

FIG. 3 a third embodiment of the first group of preferred embodiments of an arrangement according to the invention,

FIG. 4 a fourth embodiment of the first group of preferred embodiments of an arrangement according to the invention,

FIG. 5 a first embodiment of a second group of preferred embodiments of the arrangement according to the invention,

FIG. 6 a second embodiment of the second group of preferred embodiments of the arrangement according to the invention,

FIG. 7 a third embodiment of the second group of preferred embodiments of the arrangement according to the invention, and

FIG. 8 a fourth embodiment of the second group of preferred embodiments of the arrangement according to the invention,

### DETAILED DESCRIPTION OF THE PREFERRED EMBODIMENTS

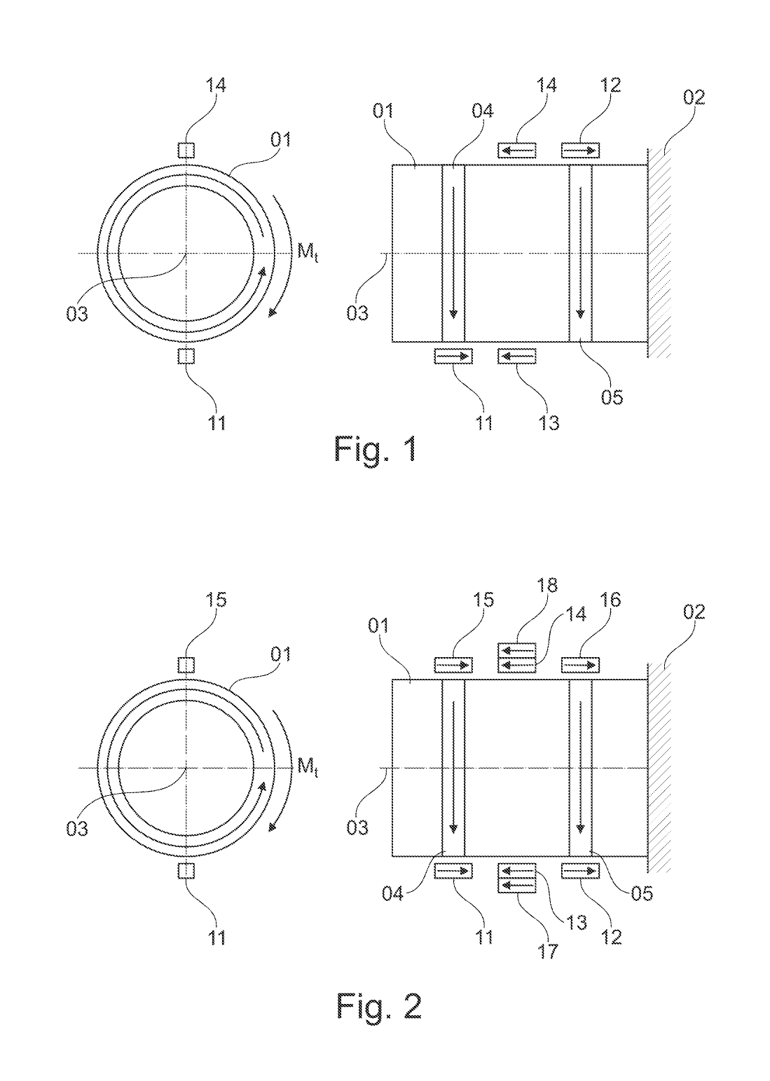

FIG. 1 to FIG. 8 show an arrangement according to the invention, each figure in two views. The left part of each figure comprises a cross-sectional view, while the right part of each figure comprises a top view of the respective embodiment of the arrangement according to the invention.

FIG. 1 shows a first embodiment of a first group of preferred embodiments of the arrangement according to the invention. The arrangement first comprises a machine element in the form of a flange 01 that is mounted on a base body 02. A force or a torque, in particular, a torque Mₜ, acts on the flange 01. The flange 01 has the shape of a hollow circular cylinder. The flange 01 extends along an axis 03 that also forms the center axis of the hollow cylindrical shape of the flange 01. The flange 01 is formed of a magneto-elastic material that has the magnetostrictive effect.

In an axial section of the flange 01, a first permanent magnetization area 04 is formed. In another axial section of the flange 01, a second permanent magnetization area 05 is formed. The permanent magnetization areas 04, 05 each extend circumferentially about the axis 03, i.e., they are circular permanent magnetizations. The polarity of the permanent magnetizations, i.e., their orientation, is identical in both permanent magnetization areas 04, 05. The two permanent magnetization areas 04, 05 are in two axially spaced apart planes.

This embodiment of the arrangement according to the invention further comprises a first magnetic field sensor 11, a second magnetic field sensor 12, a third magnetic field sensor 13, and a fourth magnetic field sensor 14. The magnetic field sensors 11, 12, 13, 14 are each formed for the individual measurement of an axial directional component of a magnetic field caused by the magnetizations of the permanent magnetization areas 04, 05 and also by the force and/or by the torque.

The four magnetic field sensors 11, 12, 13, 14 are arranged in three axially spaced apart planes. The first magnetic field sensor 11 is in the same plane as the first permanent magnetization area 04. The second magnetic field sensor 12 is in the same plane as the second permanent magnetization area 05. The third magnetic field sensor 13 and the fourth magnetic field sensor 14 are together in a plane between the two permanent magnetization areas 04, 05, where the flange 01 is not magnetized, i.e., is magnetically neutral. The first magnetic field sensor 11 and the third magnetic field sensor 13 are arranged with respect to the axis 03 opposite the second magnetic field sensor 12 and the fourth magnetic field sensor 14. The first magnetic field sensor 11 and the second magnetic field sensor 12 are each polarized opposite the third magnetic field sensor 13 and the fourth magnetic field sensor 14.

FIG. 2 shows a second embodiment of the first group of preferred embodiments of the arrangement according to the invention. This second embodiment differs merely in the number and arrangement of the magnetic field sensors from the embodiment shown in FIG. 1. This second embodiment further comprises a fifth magnetic field sensor 15, a sixth magnetic field sensor 16, a seventh magnetic field sensor 17, and an eighth magnetic field sensor 18. These additional magnetic field sensors 15, 16, 17, 18 are also each formed for the individual measurement of an axial directional component of the magnetic field caused by the magnetizations of the permanent magnetization areas 04, 05 and also by the force and/or by the torque.

The eight magnetic field sensors 11, 12, 13, 14, 15, 16, 17, 18 are arranged in three axially spaced apart planes. The first magnetic field sensor 11 and the fifth magnetic field sensor 15 are in the identical plane as the first permanent magnetization area 04. The second magnetic field sensor 12 and the sixth magnetic field sensor 16 are in the identical plane as the second permanent magnetization area 05. The third magnetic field sensor 13, the fourth magnetic field sensor 14, the seventh magnetic field sensor 17, and the eighth magnetic field sensor 18 are together in a plane between the two permanent magnetization areas 04, 05, where the flange 01 is not magnetized. The first magnetic field sensor 11, the second magnetic field sensor 12, the third magnetic field sensor 13, and the seventh magnetic field sensor 17 are arranged with respect to the axis 03 opposite the fourth magnetic field sensor 14, the fifth magnetic field sensor 15, the sixth magnetic field sensor 16, and the eighth magnetic field sensor 18. The first magnetic field sensor 11, the second magnetic field sensor 12, the fifth magnetic field sensor 15, and the sixth magnetic field sensor 11 are each polarized opposite the third magnetic field sensor 13, the fourth magnetic field sensor 14, the seventh magnetic field sensor 17, and the eighth magnetic field sensor 18. The third magnetic field sensor 13 and the seventh magnetic field sensor 17 are located essentially at the same position; for example, on a front and reverse side of a circuit board (not shown). The fourth magnetic field sensor 14 and the eighth magnetic field sensor 18 are located essentially at the same position; for example, on a front and a reverse side of a circuit board (not shown).

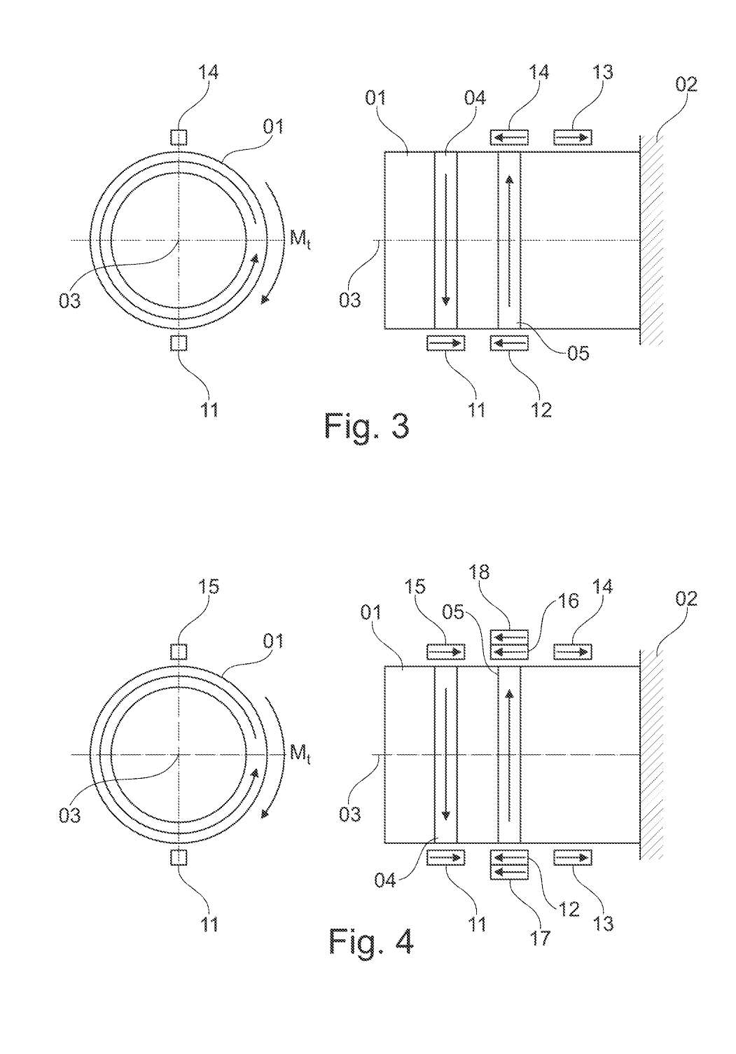

FIG. 3 shows a third embodiment of the first group of preferred embodiments of the arrangement according to the invention. This third embodiment differs merely in the polarity of the magnetization areas and in the arrangement of the magnetic field sensors from the embodiment shown in FIG. 1. In this third embodiment, the polarities of the permanent magnetizations in the two permanent magnetization areas 04, 05 are opposite each other, i.e., they have reverse orientation. The two permanent magnetization areas 04, 05 are in two axially spaced apart planes.

The four magnetic field sensors 11, 12, 13, 14 are arranged in three axially spaced apart planes. The first magnetic field sensor 11 is in the same plane as the first permanent magnetization area 04. The second magnetic field sensor 12 and the fourth magnetic field sensor 14 are together in the same plane as the second permanent magnetization area 05. The third magnetic field sensor 13 is in a plane axially next to the two permanent magnetization areas 04, 05, where the flange 01 is not magnetized. The first magnetic field sensor 11 and the second magnetic field sensor 12 are arranged with respect to the axis 03 opposite the third magnetic field sensor 13 and the fourth magnetic field sensor 14. The first magnetic field sensor 11 and the third magnetic field sensor 13 are each polarized opposite the second magnetic field sensor 12 and the fourth magnetic field sensor 14.

FIG. 4 shows a fourth embodiment of the first group of preferred embodiments of the arrangement according to the invention. This fourth embodiment differs merely in the polarity of the magnetization areas and in the arrangement of the magnetic field sensors from the embodiment shown in FIG. 2. In this fourth embodiment, the polarities of the permanent magnetizations in the two permanent magnetization areas 04, 05 are opposite each other, i.e., they have reverse orientation. The two permanent magnetization areas 04, 05 are in two axially spaced apart planes.

The eight magnetic field sensors 11, 12, 13, 14, 15, 16, 17, 18 are arranged in three axially spaced apart planes. The first magnetic field sensor 11 and the fifth magnetic field sensor 15 are in the same plane as the first permanent magnetization area 04. The second magnetic field sensor 12, the sixth magnetic field sensor 16, the seventh magnetic field sensor 17, and the eighth magnetic field sensor 18 are in the same plane as the second permanent magnetization area 05. The third magnetic field sensor 13 and the fourth magnetic field sensor 14 are together in a plane axially next to the two permanent magnetization areas 04, 05, where the flange 01 is not magnetized. The first magnetic field sensor 11, the second magnetic field sensor 12, the third magnetic field sensor 13, and the seventh magnetic field sensor 17 are arranged with respect to the axis 03 opposite the fourth magnetic field sensor 14, the fifth magnetic field sensor 15, the sixth magnetic field sensor 16, and the eighth magnetic field sensor 18. The first magnetic field sensor 11, the third magnetic field sensor 13, the fourth magnetic field sensor 14, and the fifth magnetic field sensor 15 are each polarized opposite the second magnetic field sensor 12, the sixth magnetic field sensor 16, the seventh magnetic field sensor 17, and the eighth magnetic field sensor 18. The second magnetic field sensor 12 and the seventh magnetic field sensor 17 are located essentially at the same position; for example, on a front and reverse side of a circuit board (not shown). The sixth magnetic field sensor 16 and the eighth magnetic field sensor 18 are located essentially at the same position; for example, on a front and a reverse side of a circuit board (not shown).

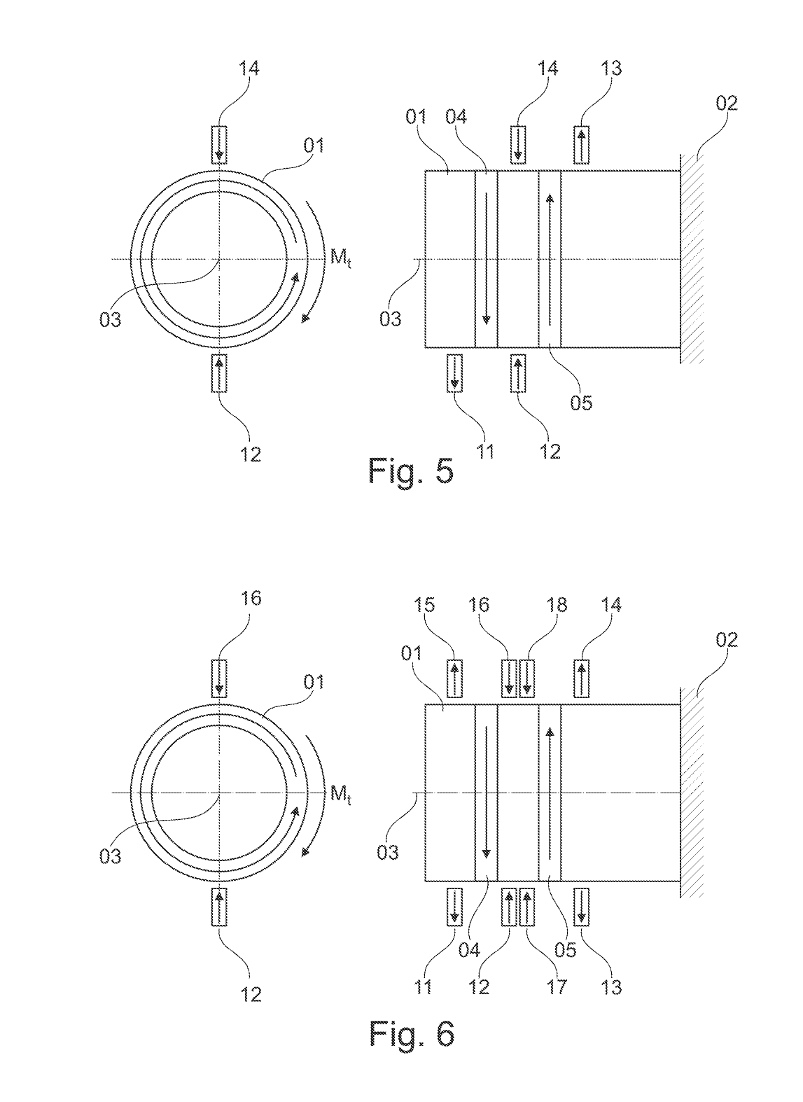

FIG. 5 shows a first embodiment of a second group of preferred embodiments of the arrangement according to the invention. The arrangement first comprises a machine element in the form of a flange 01 that is mounted on a base body 02. A force or a torque, in particular, a torque Mₜ, acts on the flange 01. The flange 01 has the shape of a hollow circular cylinder. The flange 01 extends along an axis 03 that also forms the center axis of the hollow cylindrical shape of the flange 01. The flange 01 consists of a magneto-elastic material that has the magnetostrictive effect.

In an axial section of the flange 01, a first permanent magnetization area 04 is formed. In another axial section of the flange 01, a second permanent magnetization area 05 is formed. The permanent magnetization areas 04, 05 extend circumferentially about the axis 03, i.e., they are circular permanent magnetizations. The polarity of the permanent magnetizations in the two permanent magnetization areas 04, 05 are opposite each other, i.e., they have reverse orientation. The two permanent magnetization areas 04, 05 are in two axially spaced apart planes.

This embodiment of the arrangement according to the invention further comprises a first magnetic field sensor 11, a second magnetic field sensor 12, a third magnetic field sensor 13, and a fourth magnetic field sensor 14. The magnetic field sensors 11, 12, 13, 14 are each formed for the individual measurement of a radial directional component of a magnetic field caused by the magnetizations of the permanent magnetization areas 04, 05 and also by the force and/or by the torque.

The four magnetic field sensors 11, 12, 13, 14 are arranged in three axially spaced apart planes, wherein none of the four magnetic field sensors 11, 12, 13, 14 are together in a plane with one of the permanent magnetization areas 04, 05. Instead, the magnetic field sensors 11, 12, 13, 14 are arranged in axial positions at which the flange 01 is magnetically neutral. The first magnetic field sensor 11 is in a plane axially next to the two permanent magnetization areas 04, 05, wherein the flange 01 is not magnetized, i.e., is magnetically neutral. At the opposite axial end, the third magnetic field sensor 13 is in a plane axially next to the two permanent magnetization areas 04, 05, where the flange 01 is not magnetized. The second magnetic field sensor 12 and the fourth magnetic field sensor 14 are together in a plane axially between the permanent magnetization areas 04, 05, where the flange 01 is not magnetized. The first magnetic field sensor 11 and the second magnetic field sensor 12 are arranged with respect to the axis 03 opposite the third magnetic field sensor 13 and the fourth magnetic field sensor 14. The first magnetic field sensor 11 and the fourth magnetic field sensor 14 are each polarized opposite the second magnetic field sensor 12 and the third magnetic field sensor 13.

FIG. 6 shows a second embodiment of the second group of preferred embodiments of the arrangement according to the invention. This second embodiment differs merely in the number and arrangement of the magnetic field sensors from the embodiment shown in FIG. 5. This second embodiment further comprises a fifth magnetic field sensor 15, a sixth magnetic field sensor 16, a seventh magnetic field sensor 17, and an eighth magnetic field sensor 18. These additional magnetic field sensors 15, 16, 17, 18 are also each formed for the individual measurement of a radial directional component of a magnetic field caused by the magnetizations of the permanent magnetization areas 04, 05 and also by the force and/or by the torque.

The eight magnetic field sensors 11, 12, 13, 14, 15, 16, 17, 18 are arranged in three axially spaced apart planes, wherein none of the eight magnetic field sensors 11, 12, 13, 14, 15, 16, 17, 18 are together in a plane with one of the permanent magnetization areas 04, 05. Instead, the magnetic field sensors 11, 12, 13, 14, 15, 16, 17, 18 are arranged in axial positions at which the flange 01 is magnetically neutral. The first magnetic field sensor 11 and the fifth magnetic field sensor 15 are in a plane axially next to the two permanent magnetization areas 04, 05, where the flange 01 is not magnetized. At the opposite axial end, the third magnetic field sensor 13 and the fourth magnetic field sensor 14 are in a plane axially next to the two permanent magnetization areas 04, 05, where the flange 01 is not magnetized. The second magnetic field sensor 12, the sixth magnetic field sensor 16, the seventh magnetic field sensor 17, and the eighth magnetic field sensor 18 are together in a plane between the two permanent magnetization areas 04, 05, where the flange 01 is not magnetized. The first magnetic field sensor 11, the second magnetic field sensor 12, the third magnetic field sensor 13, and the seventh magnetic field sensor 17 are arranged with respect to the axis 03 opposite the fourth magnetic field sensor 14, the fifth magnetic field sensor 15, the sixth magnetic field sensor 16, and the eighth magnetic field sensor 18. The first magnetic field sensor 11, the third magnetic field sensor 13, the sixth magnetic field sensor 16, and the eighth magnetic field sensor 18 are each polarized opposite the second magnetic field sensor 12, the fourth magnetic field sensor 14, the fifth magnetic field sensor 15, and the seventh magnetic field sensor 17. The second magnetic field sensor 12 and the seventh magnetic field sensor 17 are located essentially at the same position; for example, on a front and a reverse side of a circuit board (not shown). The sixth magnetic field sensor 16 and the eighth magnetic field sensor 18 are located essentially at the same position; for example, on a front and a reverse side of a circuit board (not shown).

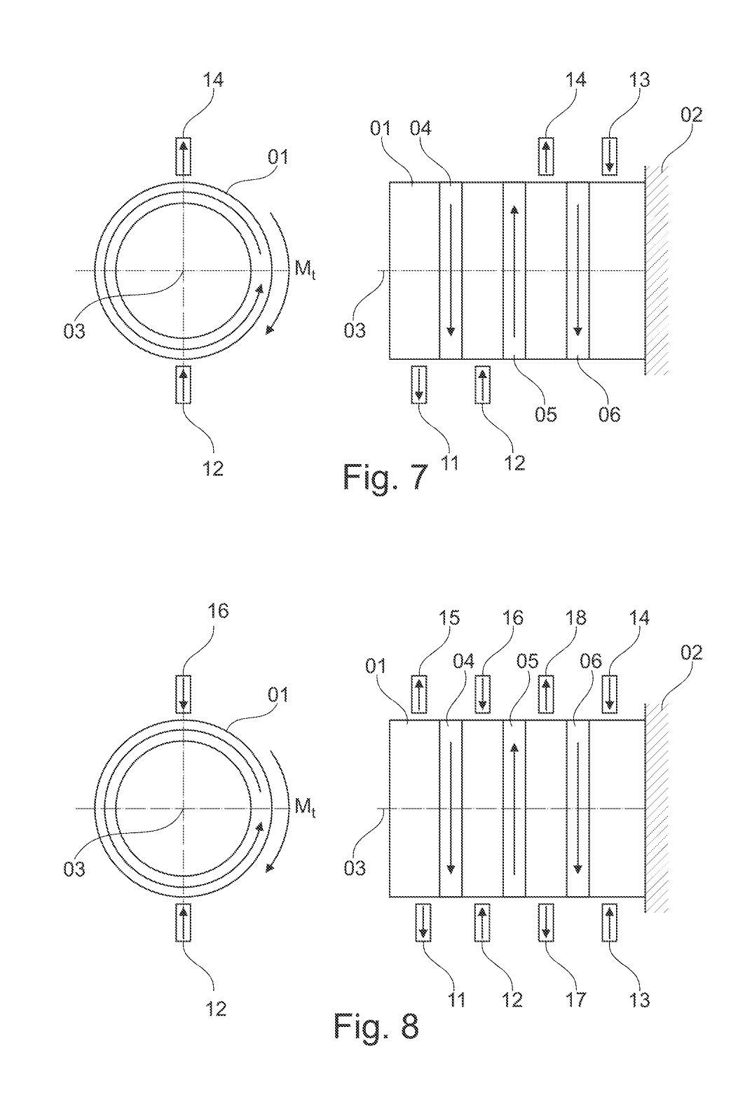

FIG. 7 shows a third embodiment of the second group of preferred embodiments of the arrangement according to the invention. This third embodiment differs merely in the number and polarity of the magnetization areas and in the arrangement of the magnetic field sensors from the embodiment shown in FIG. 5. This third embodiment has a third magnetization area 06, wherein the polarity of the permanent magnetization of the axially center, second permanent magnetization area 05 is oriented opposite the polarities of the permanent magnetizations of the two axially outer permanent magnetization areas 04, 06, i.e., the first permanent magnetization area 04 and the third permanent magnetization area 06, i.e., they have a reverse orientation. The three permanent magnetization areas 04, 05, 06 are in three axially spaced apart planes.

The four magnetic field sensors 11, 12, 13, 14 are arranged in three axially spaced apart planes, wherein none of the four magnetic field sensors 11, 12, 13, 14 are together in a plane with one of the permanent magnetization areas 04, 05, 06. Instead, the magnetic field sensors 11, 12, 13, 14 are arranged in axial positions at which the flange 01 is magnetically neutral. The first magnetic field sensor 11 is in a plane axially next to the three permanent magnetization areas 04, 05, 06, where the flange 01 is not magnetized. At the opposite axial end, the third magnetic field sensor 13 is in a plane axially next to the three permanent magnetization areas 04, 05, 06, where the flange 01 is not magnetized. The second magnetic field sensor 12 is in a plane axially between the axially outer first permanent magnetization area 04 and the axially center, second permanent magnetization areas 05, where the flange 01 is not magnetized. The fourth magnetic field sensor 14 is in a plane between the axially outer third permanent magnetization area 06 and the axially center, second permanent magnetization area 05, where the flange 01 is not magnetized. The first magnetic field sensor 11 and the second magnetic field sensor 12 are arranged with respect to the axis 03 opposite the third magnetic field sensor 13 and the fourth magnetic field sensor 14. The first magnetic field sensor 11 and the third magnetic field sensor 13 are each polarized opposite the second magnetic field sensor 12 and the fourth magnetic field sensor 14.

FIG. 8 shows a fourth embodiment of the second group of preferred embodiments of the arrangement according to the invention. This fourth embodiment differs merely in the number and polarity of the magnetization areas and in the arrangement of the magnetic field sensors from the embodiment shown in FIG. 6. This third embodiment has a third magnetization area 06, wherein the polarity of the permanent magnetization of the axially center, second permanent magnetization area 05 is oriented opposite the polarities of the permanent magnetizations of the two axially outer permanent magnetization areas 04, 06, i.e., of the first permanent magnetization area 04 and the second permanent magnetization area 06, i.e., they have a reverse orientation. The three permanent magnetization areas 04, 05, 06 are in three axially spaced apart planes.

The eight magnetic field sensors 11, 12, 13, 14, 15, 16, 17, 18 are arranged in three axially spaced apart planes, wherein none of the eight magnetic field sensors 11, 12, 13, 14, 15, 16, 17, 18 are together in a plane with one of the permanent magnetization areas 04, 05, 06. Instead, the magnetic field sensors 11, 12, 13, 14, 15, 16, 17, 18 are arranged in axial positions at which the flange 01 is magnetically neutral. The first magnetic field sensor 11 and the fifth magnetic field sensor 15 are together in a plane axially next to the three permanent magnetization areas 04, 05, 06, where the flange 01 is not magnetized. At the opposite axial end, the third magnetic field sensor 13 and the fourth magnetic field sensor 14 are in a plane axially next to the three permanent magnetization areas 04, 05, 06, where the flange 01 is not magnetized. The second magnetic field sensor 12 and the sixth magnetic field sensor 16 are together in a plane between the axially outer first permanent magnetization area 04 and the axially center, second permanent magnetization area 05, where the flange 01 is not magnetized. The seventh magnetic field sensor 17 and the eighth magnetic field sensor 18 are together in a plane between the axially outer third permanent magnetization area 06 and the axially center, second permanent magnetization area 05, where the flange 01 is not magnetized. The first magnetic field sensor 11, the second magnetic field sensor 12, the third magnetic field sensor 13, and the seventh magnetic field sensor 17 are arranged with respect to the axis 03 opposite the fourth magnetic field sensor 14, the fifth magnetic field sensor 15, the sixth magnetic field sensor 16, and the eighth magnetic field sensor 18. The first magnetic field sensor 11, the fourth magnetic field sensor 14, the sixth magnetic field sensor 16, and the seventh magnetic field sensor 17 are each polarized opposite the second magnetic field sensor 12, the third magnetic field sensor 13, the fifth magnetic field sensor 15, and the eighth magnetic field sensor 18.

### LIST OF REFERENCE NUMBERS

01 Flange
02 Base body
03 Axis
04 First permanent magnetization area
05 Second permanent magnetization area
06 Third permanent magnetization area
07
08
09
11 First magnetic field sensor
12 Second magnetic field sensor
13 Third magnetic field sensor
14 Fourth magnetic field sensor
15 Fifth magnetic field sensor
16 Sixth magnetic field sensor
17 Seventh magnetic field sensor
18 Eighth magnetic field sensor

1. An arrangement for measuring at least one of a force or a torque (Mₜ) on a machine element extending along an axis, comprising: at least first and second magnetization areas extending circumferentially about the axis of the machine element for a magnetization, magnetically neutral areas on the machine element each of which are arranged at least one of axially between the magnetization areas or axially next to the magnetization areas, at least one first magnetic field sensor, a second magnetic field sensor, and a third magnetic field sensor each of which are formed for individual measurement of one directional component of a magnetic field caused by the magnetization and also by the at least one of the force or the torque (Mₜ) and are located at different axial positions, and the third magnetic field sensor is located at one axial position of one of the magnetically neutral areas.

2. The arrangement according to claim 1, wherein a directional component of the magnetic field caused by the magnetization and also by the at least one of the force or the torque (Mₜ) is formed by an axial directional component, said directional component is measured by the magnetic field sensors, and the first magnetic field sensor is located at an axial position of the first magnetization area and the second magnetic field sensor is located at an axial position of the second magnetization area.

3. The arrangement according to claim 2, wherein the first magnetization area and the second magnetization area have an identical polarity, the magnetically neutral area at whose axial position the third magnetic field sensor is located is arranged axially between the first magnetization area and the second magnetization area, and the arrangement further comprises at least one fourth magnetic field sensor for individual measurement of an axial directional component of the magnetic field caused by the magnetization and also by the at least one of force or the torque (Mₜ).

4. The arrangement according to claim 2, wherein the first magnetization area and the second magnetization area have opposite polarities, the magnetically neutral area at whose axial position the third magnetic field sensor is located is arranged axially next to the two magnetization areas, and the arrangement further comprises at least one fourth magnetic field sensor for individual measurement of an axial directional component of the magnetic field caused by the magnetization and also by the at least one of the force or by the torque (Mₜ).

5. The arrangement according to claim 1, wherein the directional component of the magnetic field caused by the magnetization and also by the at least one of the force or the torque (Mₜ) is formed by a radial directional component, said directional component is measured by the magnetic field sensors, the first magnetic field sensor is located at an axial position of one of the magnetically neutral areas, and the second magnetic field sensor is located at an axial position of one of the magnetically neutral areas.

6. The arrangement according to claim 5, wherein the first magnetization area and the second magnetization area have opposite polarities, the magnetically neutral area at whose axial position the third magnetic field sensor is located is arranged axially next to the two magnetization areas, and the arrangement further comprises at least one fourth magnetic field sensor for the individual measurement of a radial directional component of the magnetic field caused by the magnetization and also by the at least one of the force or by the torque (Mₜ).

7. The arrangement according to claim 5, wherein the machine element further comprises a third magnetization area extending circumferentially about the axis for a magnetization, the first magnetization area and the third magnetization area have an identical polarity that is oriented opposite a polarity of the second magnetization area located axially in-between, the magnetically neutral area at whose axial position the third magnetic field sensor is located is arranged axially next to the three magnetization areas, and the arrangement further comprises at least one fourth magnetic field sensor for the individual measurement of a radial directional component of the magnetic field caused by the magnetization and also by the at least one of the force or the torque (Mₜ).

8. The arrangement according to claim 1, wherein the magnetization areas are permanently magnetized, so that the magnetization is formed by a permanent magnetization.

9. The arrangement according to claim 1, wherein magnetization areas are formed in a ring shape about the axis.

10. The arrangement according to claim 1, wherein the magnetic field sensors have an identical distance to the axis.
